(19) United States
(12) Patent Application Publication
(10) Pub. No.: US 2025/0299130 A1
(43) Pub. Date: Sep. 25, 2025

(54) ARTICLE MANAGEMENT SYSTEM, ARTICLE MANAGEMENT METHOD, AND RECORDING MEDIUM HAVING RECORDED THEREON ARTICLE MANAGEMENT PROGRAM

(71) Applicant: SHARP KABUSHIKI KAISHA, Sakai City (JP)

(72) Inventors: THINH NGUYENQUANG, Sakai City (JP); Hiroshi Yamauchi, Sakai City (JP); Eiji Kurimoto, Sakai City (JP)

(21) Appl. No.: 19/062,271

(22) Filed: Feb. 25, 2025

(30) Foreign Application Priority Data
Mar. 22, 2024 (JP) 2024-046026

(51) Int. Cl. G06Q 10/0631; G06Q 10/04; G06Q 10/087

(52) U.S. Cl. CPC G06Q 10/06315; G06Q 10/04; G06Q 10/087

(57) ABSTRACT

The management server includes an acquisition processing circuit that acquires an individual picking processing time when each of a plurality of articles is arranged at each of a plurality of arrangement positions, a prediction processing circuit that acquires picking prediction information of the article, an evaluation processing circuit that evaluates a combination picking processing time corresponding to a plurality of arrangement position combinations based on the individual picking processing time and the picking prediction information, and a determination processing circuit that determines one arrangement position combination from the plurality of arrangement position combinations based on the combination picking processing time.

### INCORPORATION BY REFERENCE

This application is based upon and claims the benefit of priority from the corresponding Japanese Patent Application No. 2024-046026 filed on Mar. 22, 2024, the entire contents of which are incorporated herein by reference.

### BACKGROUND

The disclosure relates to a technique of arranging an article to be picked.

In a warehouse or the like, there has been introduced a system that picks an article arranged on a shelf and conveys the article to a predetermined place when a picking order is received. There has been proposed a technique of optimizing the arrangement of articles with respect to a shelf in the system. For example, a technology has been proposed in which, for each of a plurality of frontage spaces of a plurality of shelves, a recommended capacity value of an article is calculated based on a future demand prediction of the article arranged in the frontage space, and a replacement pair of the frontage spaces are determined.

However, in the related art, since the article is arranged based on the demand prediction and the time related to picking of the article is not considered, it is difficult to arrange the article at the optimum position.

### SUMMARY

An object of the disclosure is to provide an article management system, an article management method, and a storage medium storing an article management program capable of arranging an article to be picked at an optimum position.

An article management system according to an aspect of the disclosure is an article management system that determines an arrangement position combination of a plurality of articles with respect to a plurality of arrangement positions. The article management system includes an acquisition processing circuit, a prediction processing circuit, an evaluation processing circuit, and a determination processing circuit. The acquisition processing circuit acquires an individual picking processing time when each of the plurality of articles is arranged at each of the plurality of arrangement positions. The prediction processing circuit acquires picking prediction information of the article. The evaluation processing circuit evaluates a combination picking processing time corresponding to a plurality of arrangement position combinations based on the individual picking processing time and the picking prediction information. The determination processing circuit determines one arrangement position combination from among the plurality of arrangement position combinations based on the combination picking processing time.

An article management method according to another aspect of the disclosure is an article management method of determining an arrangement position combination of a plurality of articles arranged at a plurality of arrangement positions. In the article management method, one or more processors execute: acquiring an individual picking processing time when each of the plurality of articles is arranged at each of the plurality of arrangement positions; acquiring picking prediction information of the article; evaluating a combination picking processing time corresponding to a plurality of arrangement position combinations based on the individual picking processing time and the picking prediction information; and determining one arrangement position combination from the plurality of arrangement position combinations based on the combination picking processing time.

A storage medium according to another aspect of the disclosure is a storage medium storing an article management program that determines an arrangement position combination of a plurality of articles arranged at a plurality of arrangement positions. The article management program is an article management program that causes one or more processors to execute: acquiring an individual picking processing time when each of the plurality of articles is arranged at each of the plurality of arrangement positions; acquiring picking prediction information of the article; evaluating a combination picking processing time corresponding to a plurality of arrangement position combinations based on the individual picking processing time and the picking prediction information; and determining one arrangement position combination from among the plurality of arrangement position combinations based on the combination picking processing time.

According to the disclosure, it is possible to provide an article management system, an article management method, and a recording medium storing an article management program capable of arranging an article to be picked at an optimum position.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of an article management system according to an embodiment of the disclosure.

FIG. 2 is a diagram schematically illustrating a configuration of a facility to which the article management system according to the embodiment of the disclosure is applied.

FIG. 3 is an external view illustrating an example of a storage shelf according to an embodiment of the disclosure.

FIG. 4 is a diagram illustrating an example of product information utilized in the article management system according to the embodiment of the disclosure.

FIG. 5 is a diagram illustrating an example of order information utilized in the article management system according to the embodiment of the disclosure.

FIG. 6 is a diagram illustrating an example of transport information utilized in the article management system according to the embodiment of the disclosure.

FIG. 7 is a diagram illustrating an example of history information utilized in the article management system according to the embodiment of the disclosure.

FIG. 8 is a diagram illustrating an example of shipment volume information utilized in the article management system according to the embodiment of the disclosure.

FIG. 9 is a diagram schematically illustrating rearrangement of articles (products) in the article management system according to the embodiment of the disclosure.

FIG. 10 is a diagram illustrating an example of an arrangement state of items according to an embodiment of the disclosure.

FIG. 11 is a table illustrating a calculation example of ProcessTime (process time) of an objective function according to an embodiment of the disclosure.

FIG. 12 is a table illustrating a calculation example of MoveTime (move time) of an objective function according to an embodiment of the disclosure.

FIG. 13 is a table illustrating a calculation example of ReplaceTime (replace time) of an objective function according to an embodiment of the disclosure.

FIG. 14 is a diagram illustrating an example of rearrangement results of items according to an embodiment of the disclosure.

FIG. 15 is a flowchart illustrating an example of a procedure of arrangement position determination process executed by the article management system according to the embodiment of the disclosure.

### DETAILED DESCRIPTION

Embodiments of the disclosure will be described below with reference to the attached drawings for an understanding of the disclosure. Note that the following embodiments are specific examples of the disclosure, and do not limit the technical scope of the disclosure.

### Management System 10

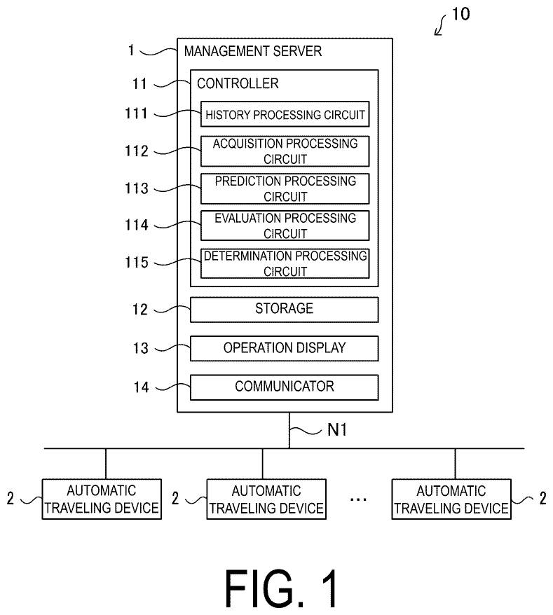

As illustrated in FIG. 1, a management system 10 according to an embodiment of the disclosure includes a management server 1 and an automatic traveling device 2 (also referred to as an automated guided vehicle (AGV) or an unmanned transport device). The management server 1 and the automatic traveling device 2 can communicate with each other via a communication network N1 such as a wireless local area network (LAN).

The management system 10 is a system that sets a plurality of paths on which the automatic traveling device 2 can travel, and designates, among the plurality of paths, a path on which the automatic traveling device 2 should travel as a travel route, and causes the automatic traveling device 2 to transport an article from a storage position to a target position. The management system 10 is applied to, for example, a facility such as a factory or a warehouse that stores products. For example, the management system 10, upon receipt of an order for a product from a customer (customer terminal), outputs a travel instruction (a transport request) to the automatic traveling device 2. The automatic traveling device 2, upon acquisition of the travel instruction, moves to the storage position (storage shelf) of the product, picks the product, and transports the product to a shipping location (dispatch location). The customer can utilize an information processing device (customer terminal) such as a personal computer or a smartphone to access a website (order page) operated by an order server (not illustrated) and place an order for a product.

The order server is capable of receiving an order of the product from each of a plurality of customer terminals and collects and outputs the received order information to the management server 1. The management server 1 manages the operation of each of the plurality of automatic traveling devices 2, and outputs travel instructions to each automatic traveling device 2 based on the order information. The automatic traveling device 2 autonomously travels on a travel route set in advance based on the travel instructions, picks a product included in the order information from a storage shelf, and transports the product to a shipment location. Note that the autonomous traveling method of the automatic traveling device 2 is not particularly limited, and a well-known method, for example, a method utilizing a magnetic tape installed on a floor surface and a marker defining a traveling operation (control information) can be employed.

For example, a plurality of containers (holders) are mounted on the automatic traveling device 2, and by holding ordered products of customers in each container, products of a plurality of customers can be collectively transported by one picking traveling (traveling of moving from a waiting location to a shipping location by circulating each shelf). For example, when the automatic traveling device 2 is equipped with two containers, the automatic traveling device 2 can collectively transport ordered products of two customers. The management server 1 outputs the travel instructions corresponding to the order information of one or a plurality of customers to each automatic traveling device 2.

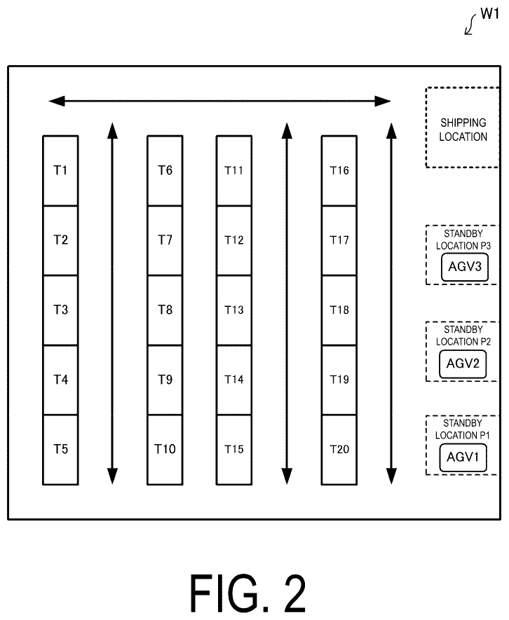

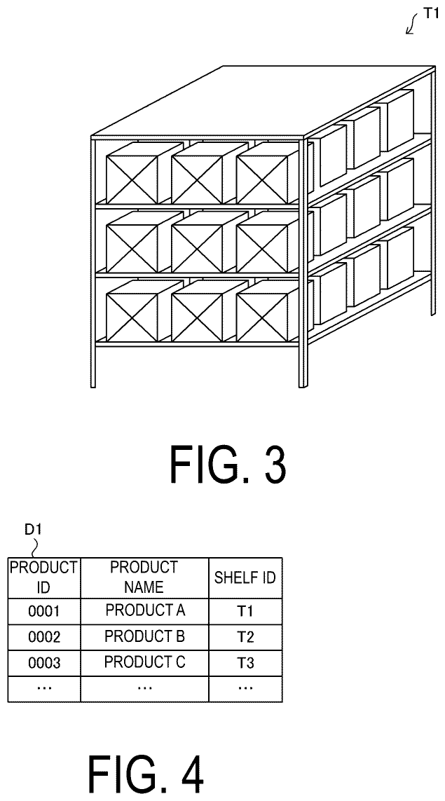

FIG. 2 illustrates an example of a facility W1 to which the management system 10 is applied. In the facility W1 illustrated in FIG. 2, a plurality of storage shelves for storing products are arranged. Twenty storage shelves T1 to T20 are illustrated in FIG. 2. In each of the storage shelves T1 to T20, a position at which the automatic traveling device 2 picks a product is set. As illustrated in FIG. 3, a plurality of products are stored in each storage shelf. For example, a plurality of product belonging to the same product group are stored in the storage shelf T1.

In the facility W1, standby locations for the automatic traveling devices 2 are set. For example, in the facility W1, a standby location P1 where an AGV1 waits, a standby location P2 where an AGV2 waits, and a standby location P3 where an AGV3 waits are set. Each of the automatic traveling devices 2 waits at a predetermined standby location when travel instructions are not received from the management server 1.

Each automatic traveling device 2, upon acquisition of travel instructions from the management server 1, moves from the standby location to the storage shelf that stores the ordered product. For example, the AGV1, upon acquisition of the travel instruction including the product in the storage shelf T1 in the order information from the management server 1, moves to the picking position corresponding to the storage shelf T1 according to the preset travel route, and moves to the shipping location according to the preset travel route when picking the ordered product or receiving the ordered product from the worker in charge of the picking work at the picking position.

Here, in order to enhance the work efficiency of the picking work of the products in the facility W1, it is desirable to arrange each product in advance at a position where each product can be easily picked (a position where the products can be efficiently delivered). The management system 10 according to the present embodiment has a configuration in which an article (product) to be picked can be arranged at an optimum position as described below.

Note that in the present embodiment, the management system 10 corresponds to the article management system according to the disclosure. However, the article management system according to the disclosure may be constituted by the management server 1 alone, or may include one or more components of the management server 1 and the automatic traveling device 2.

### Management Server 1

As illustrated in FIG. 1, the management server 1 is a server including a controller 11, a storage 12, an operation display 13, a communicator 14, and the like. Note that the management server 1 is not limited to being a single computer, and may be a computer system in which a plurality of computers operate in cooperation with each other. The various types of processing executed by the management server 1 may be distributed and executed by one or more processors.

The communicator 14 is a communication interface for connecting the management server 1 to the communication network N1 in a wired or wireless manner and executing data communication with one or more automatic traveling devices 2 via the communication network N1 in accordance with a predetermined communication protocol.

The operation display 13 is a user interface including a display such as a liquid crystal display or an organic electroluminescent (EL) display that displays various types of information, and an operation unit such as a mouse, a keyboard, or a touch panel that receives an operation.

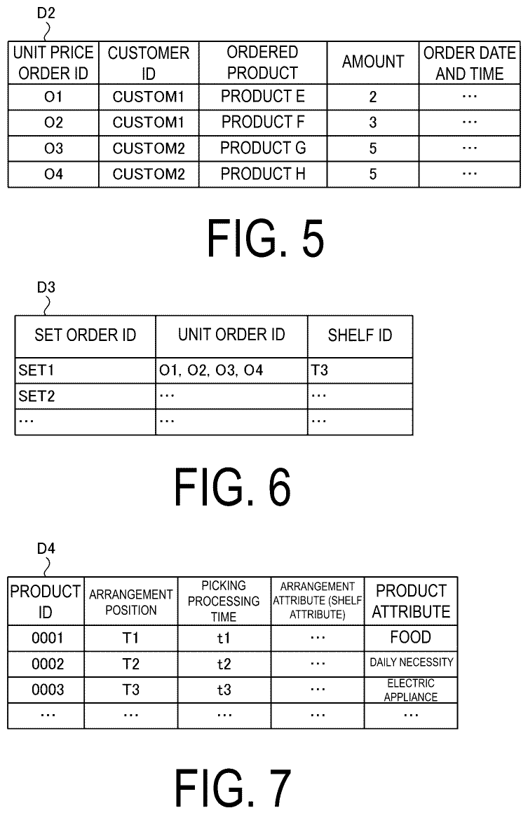

The storage 12 is a non-volatile storage such as a hard disk drive (HDD), a solid state drive (SSD), or a flash memory that stores various types of information. Specifically, the storage 12 stores data such as product information D1, order information D2, transport information D3, and history information D4. The product information D1 includes information related to the products stored in the facility W1. The order information D2 includes information related to the customer's order. The transport information D3 includes information related to a storage position of the product for the customer's order. The history information D4 includes information related to past picking operations of the products. FIG. 4 is a diagram illustrating an example of the product information D1, FIG. 5 is a diagram illustrating an example of the order information D2, FIG. 6 is a diagram illustrating an example of the transport information D3, and FIG. 7 is a diagram illustrating an example of the history information D4.

As illustrated in FIG. 4, the product information D1 includes information such as corresponding “product ID,” “product name,” and “shelf ID” for each product. The product ID is identification information of a product, and the product name is a name of the product. The shelf ID is identification information of a storage shelf in which the product is stored. In the present embodiment, as the shelf ID, for example, “T1” indicating the storage shelf T1, “T2” indicating the storage shelf T2, “T3” indicating the storage shelf T3, and the like are registered.

The product information D1 is stored in advance in the storage 12 by, for example, a registration operation of a manager of the facility W1. The manager can appropriately update the product information D1.

As illustrated in FIG. 5, the order information D2 includes, for each order, information such as “unit order ID”, “customer ID”, “ordered product”, “quantity”, and “order date and time”. The unit order ID is identification information of one order, and the customer ID is identification information of a customer who orders a product. The ordered product is a name of a product ordered by the customer, and the quantity is an order quantity of the ordered product. The order date and time is information on the date and time when the order is received from the customer.

The order information D2 is registered by the controller 11 each time the management server 1 (or the order server) receives an order from a customer.

As illustrated in FIG. 6, the transport information D3 includes information such as “set order ID”, “unit order ID”, and “shelf ID” corresponding to each set order obtained by combining unit orders. The set order ID is identification information of a set order obtained by combining unit orders. The controller 11 generates a set order by combining unit orders based on information such as a storage position of a product, a current position of the automatic traveling device 2, and an operation rule.

The transport information D3 is included in the travel instruction transmitted to the automatic traveling device 2. For example, when the AGV1 acquires the travel instruction including the transport information D3 of the “SET1”, the AGV1 moves to the position of the shelf ID “T3” included in the transport information D3. Then, the AGV1 picks the products of the unit order IDs “O1”, “O2”, “O3”, and “O4” in the storage shelf T3. The controller 11 generates the transport information D3 (see FIG. 6) with reference to the product information D1 (see FIG. 4).

As illustrated in FIG. 7, the history information D4 includes the result information of the past picking processing for each product. For example, the history information D4 includes information such as “arrangement position”, “picking processing time”, “arrangement attribute”, and “product attribute” corresponding to each product. The arrangement position is identification information (shelf ID) of the storage shelf in which the product has been stored. The picking processing time is a time taken for the automatic traveling device 2 to transport a product to the shipping location after the product is taken out from the storage shelf. The arrangement attribute is information (characteristic information) related to a position at which a product is arranged (storage shelf), and is information such as a size, a shape, a width of a picking frontage, a width of a storage space, and a width of a work space of the storage shelf. The product attribute is information (characteristic information) such as a type (food, daily necessity, electric appliance, or the like), a size, and a weight of the product.

The picking processing time changes according to the arrangement position, the arrangement attribute, and the product attribute. Since the arrangement position (storage shelf) of each product is not necessarily fixed, each product may be arranged at a different arrangement position for each picking. Therefore, for example, for the product A, the picking processing time when the product A is arranged in the storage shelf T1, the picking processing time when the product A is arranged in the storage shelf T3, and the picking processing time when the product A is arranged in a storage shelf T5 may be different from each other. As described above, the history information D4 includes the characteristic information (attribute) of the arrangement position and the characteristic information (attribute) of the product. Every time the controller 11 executes picking processing, the controller 11 registers the result information of the picking processing in the history information D4.

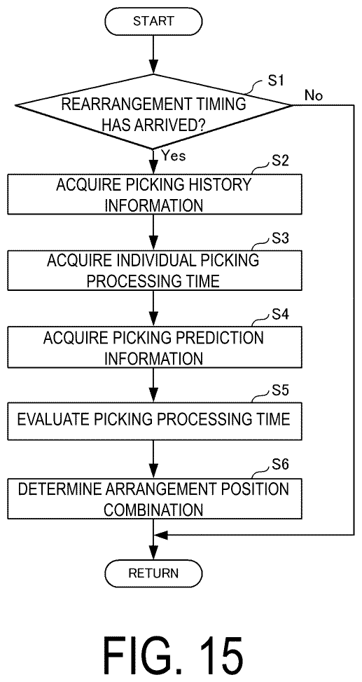

Note that, as another embodiment, some or all of the product information D1, the order information D2, the transport information D3, and the history information D4 may be stored in another server accessible from the management server 1 via the network N1. In this case, the controller 11 of the management server 1 may acquire the information from the another server and execute processing such as an arrangement position determination processing described below (refer to FIG. 15).

The storage 12 stores a control program such as a arrangement position determination program for causing the controller 11 to execute the arrangement position determination processing described below (see FIG. 15). For example, the arrangement position determination program is non-temporarily recorded in a computer-readable recording medium such as a compact disc (CD) or a digital versatile disc (DVD), read by a reading device (not illustrated) such as a CD drive or a DVD drive included in the management server 1, and stored in the storage 12.

The controller 11 includes control devices such as a central processing unit (CPU), a read only memory (ROM), and a random access memory (RAM). The CPU is a processor that executes various types of arithmetic processing. The ROM is non-volatile storage that stores, in advance, control programs such as a basic input/output system (BIOS) and an operating system (OS) for causing the CPU to execute various types of calculation processing. The RAM is a volatile or non-volatile storage that stores various types of information and is used as a temporary storage memory (work area) for the various types of processing executed by the CPU. The controller 11 controls the management server 1 by causing the CPU to execute various types of the control programs stored in advance in the ROM or the storage 12.

Specifically, as illustrated in FIG. 1, the controller 11 includes various types of processing circuits such as a history processing circuit 111, an acquisition processing circuit 112, a prediction processing circuit 113, an evaluation processing circuit 114, and a determination processing circuit 115. Note that the controller 11 functions as the various types of processing circuits by executing various types of processing in accordance with the traveling program using the CPU. Some or all of the processing circuits may be constituted by an electronic circuit. Note that the traveling program may be a program for causing a plurality of processors to function as the processing circuits.

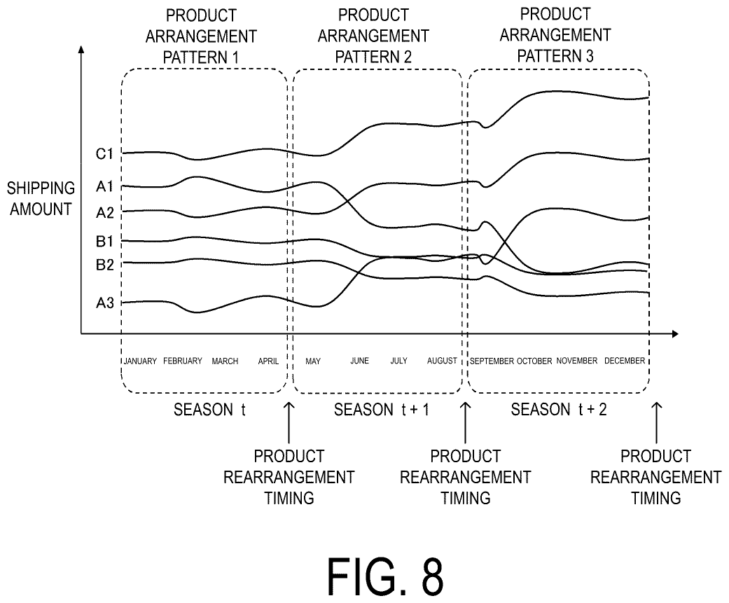

The controller 11 executes processing of determining (optimizing) a combination of optimum arrangement positions (hereinafter, referred to as an “arrangement position combination”) of a plurality of products arranged at a plurality of arrangement positions (storage shelves). FIG. 8 illustrates changes in past shipping amounts (order amounts) of the products A, B, and C for each month and season. As described above, for each product, there is a constant tendency in the change of the shipping amount, such as when the shipping amount is large or when the shipping amount is small. In the example illustrated in FIG. 8, three patterns of tendencies of January to April (season t), May to August (season t+1), and September to December (season t+2) can be seen. Therefore, it is appropriate to change (rearrange) the arrangement position (storage location) of each product at the timing at which the tendency of the shipping amount changes.

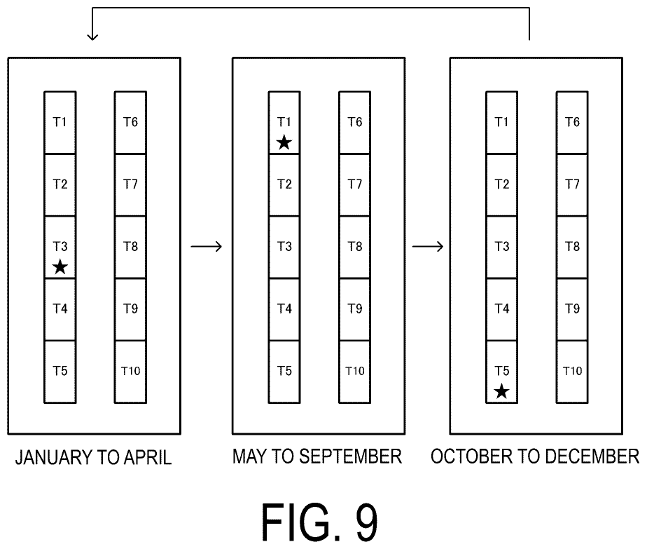

For example, products are arranged according to a product arrangement pattern 1 in January to April (season t), rearranged at the end of April and arranged according to a product arrangement pattern 2 in May to August (season t+1), rearranged at the end of August and arranged according to a product arrangement pattern 3 in September to December (season t+2), rearranged at the end of December and arranged according to the product arrangement pattern 1 again in January to April (season t). Accordingly, for example, when focusing on one product, as illustrated in FIG. 9, the product is arranged in the storage shelf T3 in January to April, the product is arranged in the storage shelf T1 in May to August, and the product is arranged in the storage shelf T5 in September to December, and thereafter, the product is rearranged in this cycle.

As described above, the efficiency of the picking processing can be improved by rearranging the products according to the tendency of the shipping amount. Specific processing of each processing circuit for determining the arrangement position combination will be described below.

The history processing circuit 111 acquires picking history information (history information D4 in FIG. 7) in which the past picking processing time of the product for each arrangement position is recorded. Specifically, the history processing circuit 111 refers to the history information D4 and acquires the past picking processing time of the product for each storage shelf.

The acquisition processing circuit 112 acquires the individual picking processing time when each of the plurality of products is arranged at each of the plurality of arrangement positions. Specifically, the acquisition processing circuit 112 acquires the individual picking processing time based on the history information D4.

For example, the acquisition processing circuit 112 acquires combination determination target information including characteristic information (arrangement position attribute (shelf attribute)) of an arrangement position (storage shelf) of a determination target of the arrangement position combination and characteristic information (product attribute) of a product. The acquisition processing circuit 112 compares the picking history information (history information D4) with the combination determination target information, determines the identity or similarity of the characteristic information of the arrangement position and the identity or similarity of the characteristic information of the product, and acquires the individual picking processing time based on the determination result.

Specifically, as described above, the history information D4 includes result information of the past picking processing, for example, information on how much picking processing time is required when which product is arranged at which arrangement position (storage shelf), and further includes information on attributes of the arrangement position (size of arrangement position such as widths of work space and storage space, width of frontage for picking, or the like) and attributes of the product (type of product such as food, daily necessities, electric appliances, size of product, weight of product, or the like). The acquisition processing circuit 112 calculates the picking processing time (individual picking processing time) when each of the plurality of products is arranged at each of the arrangement positions by referring to the result of the picking processing time in which the attributes of the arrangement position and the attributes of the product are the same or similar.

The prediction processing circuit 113 acquires picking prediction information of a product. Specifically, the prediction processing circuit 113 acquires an order amount (predicted order amount) of each product predicted in the future. For example, the prediction processing circuit 113 predicts the order amount based on the past order history. The prediction processing circuit 113 predicts the order amount based on the past order history of each product for each season, month, day, or time, the tendency of the order amount (see FIGS. 7 and 8), and the like.

An evaluation processing circuit 114 evaluates a combination picking processing time corresponding to a plurality of arrangement position combinations based on the individual picking processing time and the picking prediction information. The evaluation processing circuit 114 does not evaluate the picking processing time for each product and each arrangement position (storage shelf), but evaluates the plurality of arrangement position combinations. Specifically, the evaluation processing circuit 114 obtains an objective function including an evaluation term of the combination picking processing time. For example, the evaluation processing circuit 114 calculates the objective function E (x) using the following equation.

$$[ Equation 1 ]$$

$$\begin{matrix}E ( \vec{x} ) = {λ}_{1} {\sum }_{t = 1}^{D} {\sum }_{i = 1}^{I} {\sum }_{j = 1}^{J} {MoveTime}_{i , j , t} {x}_{i , j , t} ← & First term \\ + {λ}_{2} {\sum }_{t = 1}^{D} {\sum }_{i = 1}^{I} {( {\sum }_{j = 1}^{J} {ProcessTime}_{i , j , t} {x}_{i , j , t} )}^{2} ← & Second term \\ + {λ}_{3} {\sum }_{i = 1}^{I} {\sum }_{j = 1}^{J} {( {{\sum }^{{J}^{′}}}_{{j}^{′} != j} {RePlaceCost}_{{x}_{i , j} , {x}_{i , {j}^{′}} , {x}_{i , j , t}} )}^{2} ← & Third term \\ + {λ}_{4} {\sum }_{i = 1}^{I} {\sum }_{j = 1}^{J} {( {x}_{i , j , t} - 1 )}^{2} ← & Fourth term\end{matrix}$$

Note that, for convenience of explanation, the above equation is expressed as follows.

$$\begin{matrix}E ( X ) = \begin{matrix}A 1 \times SUM 1 ( MoveTime ( s , D 1 / D 2 ) \times X [ i ] [ j ] [ t ] ) . & First term\end{matrix} \\ + \begin{matrix}A 2 \times SUM 2 ( ProcessTime [ i ] [ j ] [ t ] \times X [ i ] [ j ] [ t ] ) \hat{} 2. & Second term\end{matrix} \\ + \begin{matrix}A 3 \times SUM 3 ( ReplaceTime [ s , {s}^{′} ] ) \hat{} 2. & Third term\end{matrix} \\ + \begin{matrix}A 4 \times SUM 4 ( X [ i ] [ j ] [ t ] - 1 ) \hat{} 2. & Fourth term\end{matrix}\end{matrix}$$

X [i] [j] [t] in the above equation is a decision variable and indicates that the same product group [i] is arranged at the arrangement position [j] in the season [t].

“SUM1” in the first term indicates a movement time at the time of delivery of a product, for example, a transport time required for transporting a product from an arrangement position (storage shelf) to a shipping location. MoveTime (s, D1/D2) in the first term indicates the transport time from the arrangement position s to the shipping locations D1 and D2. “SUM2” in the second term indicates a picking processing time at the time of delivery of a product. “ProcessTime” in the second term indicates a processing time at the arrangement position (storage shelf), for example, a work time required for picking work of the product. “SUM3” in the third term indicates a necessary movement time (movement time from s to s′) in the rearrangement of the product. “SUM4” in the fourth term indicates a necessary constraint condition (penalty) in the arrangement of the product, and is, for example, a condition that “each product is arranged in only one place”. That is, the evaluation term (fourth term) of the constraint condition is a function that increases the objective function when the same product is arranged at two or more arrangement positions. A1 to A4 indicate weights related to importance.

The evaluation processing circuit 114 calculates the objective function for each of the plurality of arrangement position combinations.

The determination processing circuit 115 determines one arrangement position combination from among the plurality of arrangement position combinations based on the combination picking processing time. Specifically, the determination processing circuit 115 determines the arrangement position combination in which the objective function calculated by the evaluation processing circuit 114 is the minimum among the plurality of arrangement position combinations.

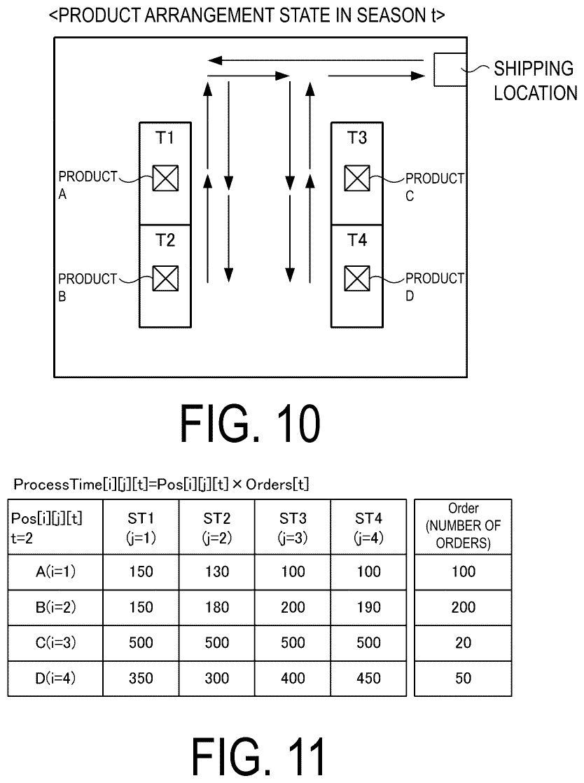

Hereinafter, a specific example of determining the arrangement position combination will be described with reference to FIGS. 10 to 13.

FIG. 10 illustrates storage shelves T1 to T4, and it is assumed that the product A is stored in the storage shelf T1, the product B is stored in the storage shelf T2, the product C is stored in the storage shelf T3, and a product D is stored in the storage shelf T4. FIG. 10 illustrates the current arrangement positions of the products A to D in the season t. Each product is picked from the storage shelf according to the order and transported to the shipping location by the automatic traveling device 2. Here, when the products A to D are rearranged at appropriate positions in preparation for future orders, a plurality of combinations (arrangement position combinations) are conceivable. For example, since the product A is allocated to any one of four storage shelves T1 to T4, the product B is allocated to three storage shelves excluding the storage shelf allocated to the product A, the product C is allocated to two storage shelves excluding the storage shelves allocated to the products A and B, and the product D is allocated to the remaining one storage shelf, there are 24 combinations of allocating (rearranging) the products A to D to the storage shelves T1 to T4. Therefore, the controller 11 calculates the objective functions corresponding to the 24 arrangement position combinations, and determines the arrangement position combination in which the objective function is the minimum.

FIG. 11 illustrates a calculation example (calculation result of the cost function) of “Process Time” (process time) of the second term of the above equation. In FIG. 11, “ST” indicates an arrangement position (storage shelf), and ST1 to ST4 indicate the storage shelves T1 to T4 (see FIG. 10), respectively. “ProcessTime” is calculated by Process Time [i] [j] [t]=Pos [i] [j] [t]×Orders [t]. Pos [i] [j] [t] represents a picking work time when a product is picked from the arrangement position ST. For example, it is indicated that the cost of the picking work time when picking the product A from the storage shelf T3 in a case where the product A is arranged in the storage shelf T3 (ST3) is “100”, and the cost of the picking work time when picking the product C from the storage shelf T1 in a case where the product C is arranged in the storage shelf T1 (ST1) is “150”. Note that the values illustrated in FIG. 11 may be time (seconds). The controller 11 calculates the ProcessTime by multiplying the picking work time by the predicted order amount (Orders [t]). That is, the controller 11 calculates the ProcessTime based on the attribute (characteristic) of the product, the attribute (characteristic) of the storage shelf, the past picking processing time, and the predicted order amount.

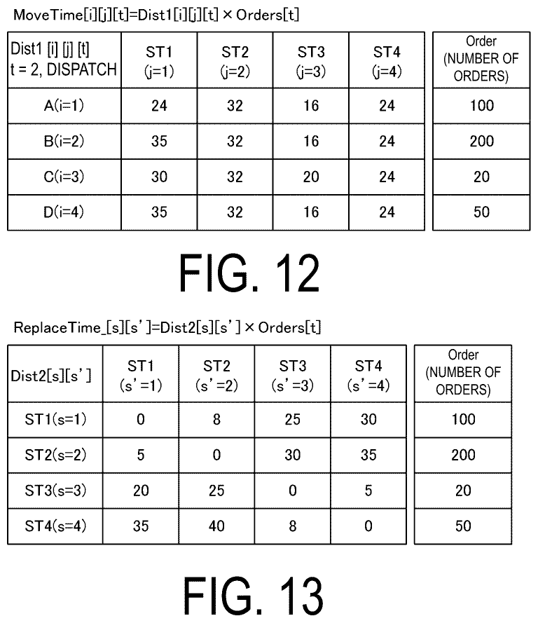

FIG. 12 illustrates a calculation example (calculation result of the cost function) of “MoveTime” (move time) of the first term of the above equation. “MoveTime” is calculated by MoveTime [i] [j] [t]=Dist1 [i] [j] [t]×Orders [t]. Dist1 [i] [j] [t] represents a transport time when the product is delivered. For example, it is indicated that the cost of the transport time required to move the product A from the storage shelf T3 to the shipping location when the product A is arranged in the storage shelf T3 (ST3) is “16”, and the cost of the transport time required to move the product C from the storage shelf T1 to the shipping location when the product C is arranged in the storage shelf T1 (ST1) is “30”. The controller 11 calculates MoveTime by multiplying the conveyance time by the predicted order amount (Orders [t]). That is, the controller 11 calculates MoveTime based on the attribute (characteristic) of the product, the attribute (characteristic) of the storage shelf, the past movement time (transport time) at the time of shipment, and the predicted order amount.

FIG. 13 illustrates a calculation example (calculation result of the cost function) of “ReplaceTime” (replacement time) of the third term of the above equation. “ReplaceTime” is calculated by ReplaceTime [s] [s′]=Dist2 [s] [s′]×Orders [t]. Dist2 [s] [s′] represents a movement time when the product is moved to the arrangement position. For example, it is indicated that the cost of the movement time required to move the product in the storage shelf T1 (ST1) to the storage shelf T3 (ST3) is “25” and the cost of the movement time required to move the product in the storage shelf T3 (ST3) to the storage shelf T1 (ST1) is “20”. The controller 11 multiplies the movement time by the predicted order amount (Orders [t]) to calculate a ReplaceTime. That is, the controller 11 calculates the ReplaceTime based on the movement distance between the storage shelves and the predicted order amount.

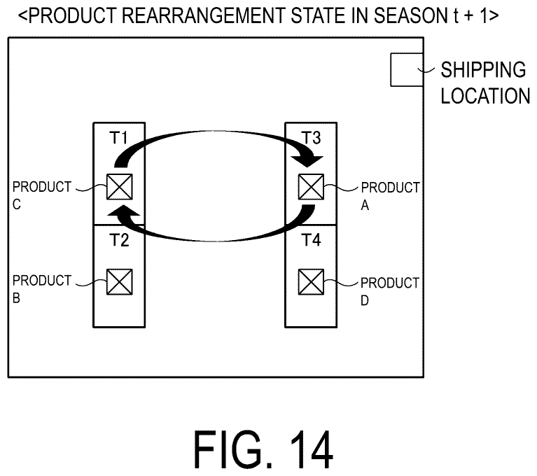

Based on the picking work time (ProcessTime), the transport time (MoveTime), and the movement time (ReplaceTime) calculated as described above, the controller 11 obtains an objective function for all the arrangement position combinations (24 combinations in the above example), and determines an arrangement position combination in which the objective function is minimized. For example, as illustrated in FIG. 14, in the next season t+1, the controller 11 determines an arrangement position combination in which the product A is arranged (moved) in the storage shelf T3, the product C is arranged (moved) in the storage shelf T1, and the product B and the product D are arranged in the storage shelves T2 and T4 without being moved.

In the above example, the controller 11 determines the arrangement position combination based on the picking work time (ProcessTime), the transport time (MoveTime), and the movement time (ReplaceTime). However, as another embodiment, the controller 11 may omit the movement time (ReplaceTime) and determine the arrangement position combination based on the picking work time (ProcessTime) and the transport time (MoveTime).

The controller 11 may determine the arrangement position combination in consideration of the constraint condition. For example, when the constraint condition of the fourth term of the above equation is a condition that “each product is arranged at only one place”, the controller 11 increases the objective function when the same product is arranged at two or more arrangement positions. Thus, it is possible to exclude the arrangement position combination which does not satisfy the constraint condition.

As described above, the controller 11 determines the arrangement position combination of each product. The controller 11 notifies the manager or the like of the facility W1 of information on the determined arrangement position combination (for example, displays the information on the manager's terminals). The manager rearranges each product based on the information of the arrangement position combination. As another embodiment, the controller 11 may output information on the determined arrangement position combination to the automatic traveling device 2. When the automatic traveling device 2 acquires the information of the arrangement position combination, the automatic traveling device 2 executes rearrangement processing for changing the arrangement position of each product. The rearrangement processing may be executed by a storage and delivery robot that automatically stores and delivers the products in each storage shelf.

In addition to the above-described processing, the controller 11 may be configured to execute processing for causing the automatic traveling device 2 to travel. Specifically, the controller 11 receives a transport request (picking order) of a product (transport target) corresponding to the automatic traveling device 2, and generates transport information. The controller 11 sets a travel route from the current position of the automatic traveling device 2 to the storage position (storage shelf) based on the transport request. For example, the controller 11 performs the operation simulation on all the automatic traveling devices 2, and sets the travel route and the control information in which the total of the transport times of all the automatic traveling devices 2 is the shortest. The controller 11 outputs travel route information including the travel route and a travel instruction including the control information to the automatic traveling device 2.

### [Arrangement Position Determination Processing]

Hereinafter, the arrangement position determination processing executed in the management system 10 will be described with reference to FIG. 15. Specifically, in the present embodiment, the arrangement position determination processing is executed by the controller 11 of the management server 1.

Note that the disclosure can be regarded as the disclosure of an arrangement position determination method that executes one or more steps included in the arrangement position determination processing. The one or more steps included in the arrangement position determination processing described herein may be omitted as appropriate. Note that each of the steps in the arrangement position determination processing may be executed in a different order within a range in which the same effect is obtained. Here, a case in which the controller 11 executes each of the steps in the arrangement position determination processing will be described as an example, but the arrangement position determination method in which one or more processors execute each of the steps in the arrangement position determination processing in a distributed manner is also conceivable as another embodiment.

First, in step S1, the controller 11 determines whether or not the rearrangement timing of the product has come. Specifically, the controller 11 determines the rearrangement timing based on the tendency of the past shipping amount (see FIG. 8). For example, in the example illustrated in FIG. 8, the controller 11 determines the end of April, the end of August, and the end of December as the rearrangement timing. When determining that the rearrangement timing has arrived (S1: Yes), the controller 11 transitions the processing to step S2. The controller 11 waits until the arrangement timing arrives (S1: No).

At step S22, the controller 11 acquires the picking history information. The controller 11 registers the result information of the picking processing in the history information D4 (see FIG. 7) every time the picking processing is executed. Then, when the rearrangement timing arrives, the controller 11 acquires the history information D4 at that time.

Next, in step S3, the controller 11 acquires the individual picking processing time. Specifically, the controller 11 calculates the picking processing time (individual picking processing time) when each of the plurality of products is arranged at each of the arrangement positions by referring to the result of the picking processing time in which the attribute of the arrangement position and the attribute of the product are the same or similar.

For example, the controller 11 acquires a picking work time (Pos [i] [j] [t] illustrated in FIG. 11) when picking the product from the arrangement position ST and a transport time (Dist1 [i] [j] [t] illustrated in FIG. 12) when delivering the product. That is, the individual picking processing time includes the picking work time and the transport time.

As another embodiment, the controller 11 may acquire the picking work time (Pos [i] [j] [t]), the transport time (Dist1 [i] [j] [t]), and the movement time (Dist2 [s] [s′] illustrated in FIG. 13) when the product is moved to the arrangement position. That is, the individual picking processing time may include the picking work time, the transport time, and the movement time.

Next, in step S4, the controller 11 acquires picking prediction information (predicted order amount). Specifically, the controller 11 predicts the order amount based on the past order history of each product for each season, month, day, or time, the tendency of the order amount (shipping amount) (see FIGS. 7 and 8), and the like. For example, the controller 11 acquires Orders [t] (predicted order amount) illustrated in FIGS. 11 to 13.

Next, in step S5, the controller 11 evaluates the picking processing time. Specifically, the controller 11 evaluates the combination picking processing time corresponding to the plurality of arrangement position combinations based on the individual picking processing time and the picking prediction information.

For example, the controller 11 calculates ProcessTime based on the picking work time (Pos [i] [j] [t]) and the predicted order amount (Orders [t]), calculates Move Time based on the transport time (Dist1 [i] [j] [t]) and the predicted order amount (Orders [t]), and obtains an objective function including the ProcessTime and MoveTime. That is, the evaluation term of the combination picking processing time includes an evaluation term (the second term of the equation) of the work time required for the picking work of the product at the arrangement position and an evaluation term (the first term of the equation) of the transport time required for transporting the product from the arrangement position to the predetermined shipping location.

As another embodiment, for example, the controller 11 may calculate ReplaceTime based on the movement time (Dist2 [s] [s′]) and the predicted order amount (Orders [t]), and obtain an objective function including ProcessTime, MoveTime, and ReplaceTime. That is, the objective function may include an evaluation term (the third term of the equation) of the cost for changing the arrangement position of the product.

As another embodiment, the objective function may include a constraint condition (for example, a condition that “each product is arranged in only one place”).

The controller 11 obtains an objective function for each of a plurality of arrangement position combinations corresponding to a plurality of products and evaluates the picking processing time (combination picking processing time) of each arrangement position combination.

Finally, in step S6, the controller 11 determines one arrangement position combination from among a plurality of arrangement position combinations based on the combination picking processing time. Specifically, the controller 11 determines the arrangement position combination in which the calculated objective function is minimized among a plurality of arrangement position combinations.

The controller 11 repeatedly executes the processing of steps S1 to S6 described above each time the rearrangement timing arrives.

As described above, the management system 10 according to the present embodiment is an article management system that determines arrangement position combinations of a plurality of articles (products) with respect to a plurality of arrangement positions (storage shelves). The management system 10 acquires an individual picking processing time when each of the plurality of articles is arranged at each of the plurality of arrangement positions, and acquires picking prediction information of the article. The management system 10 evaluates a combination picking processing time corresponding to a plurality of arrangement position combinations based on the individual picking processing time and the picking prediction information, and determines one arrangement position combination from among the plurality of arrangement position combinations based on the combination picking processing time. For example, the management system 10 determines one optimum arrangement position combination (arrangement position combination in which the objective function E (x) is minimized) using the objective function E (x) for a plurality of arrangement position combinations corresponding to a plurality of articles.

According to the above configuration, since the arrangement position of the article can be determined in consideration of the time related to picking such as the work time when picking the article, it is possible to arrange the article to be picked at an optimum position. Since it is possible to reduce the amount of calculation by using the shipping result (history information D4) which is periodically updated, it is possible to speed up the arrangement position determination processing.

### Supplementary Notes of Disclosure

Hereinafter, an outline of the disclosure extracted from the above-described embodiments will be described as supplementary notes. Note that configurations and processing functions described in the following supplementary notes can be selected and combined as desired.

### Supplementary Note 1

An article management system that determines an arrangement position combination of a plurality of articles with respect to a plurality of arrangement positions, the article management system including:
an acquisition processing circuit that acquires an individual picking processing time when each of the plurality of articles is arranged at each of the plurality of arrangement positions;
a prediction processing circuit that acquires picking prediction information of the article;
an evaluation processing circuit that evaluates a combination picking processing time corresponding to a plurality of arrangement position combinations based on the individual picking processing time and the picking prediction information; and
a determination processing circuit that determines one arrangement position combination from among the plurality of arrangement position combinations based on the combination picking processing time.

### Supplementary Note 2

The article management system according to claim 1, further including a history processing circuit that acquires picking history information in which a past picking processing time of the article for each of the arrangement positions is recorded,
wherein the acquisition processing circuit acquires the individual picking processing time based on the picking history information.

### Supplementary Note 3

The article management system according to Supplementary Note 2,
wherein the picking history information includes characteristic information of the arrangement position and characteristic information of the article, and
the acquisition processing circuit acquires combination determination target information including the characteristic information of the arrangement position of an arrangement position combination determination target and the characteristic information of the article, and acquires the individual picking processing time based on identity or similarity of the characteristic information of the arrangement position and identity or similarity of the characteristic information of the article in comparison between the picking history information and the combination determination target information.

### Supplementary Note 4

The article management system according to Supplementary Note 3,
the characteristic information of the arrangement position includes information related to a size or a shape of the arrangement position, and
the characteristic information of the article includes information related to a type, a size, or a weight of the article.

### Supplementary Note 5

The article management system according to any one of Supplementary Notes 1 to 4,
wherein the evaluation processing circuit obtains an objective function including an evaluation term of the combination picking processing time, and
the determination processing circuit determines the arrangement position combination in which the objective function is minimized.

### Supplementary Note 6

The article management system according to Supplementary Note 5,
wherein the evaluation term of the combination picking processing time includes an evaluation term of a work time required for a picking work of the article at the arrangement position and an evaluation term of a transport time required to convey the article from the arrangement position to a predetermined shipping location, the transport time being included in the picking processing time.

### Supplementary Note 7

The article management system according to Supplementary Note 5 or 6,
wherein the objective function includes an evaluation term of a cost of changing an arrangement position of the article.

### Supplementary Note 8

The article management system according to any one of Supplementary Notes 5 to 7,
wherein the objective function includes an evaluation term of a constraint condition related to an arrangement position of the article.

### Supplementary Note 9

The article management system according to Supplementary Note 8,
wherein the evaluation term of the constraint condition is a function that increases the objective function when the same article is arranged at two or more arrangement positions.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An article management system comprising:
one or more processors, the article management system determining an arrangement position combination of a plurality of articles with respect to a plurality of arrangement positions,
wherein the one or more processors:
acquire an individual picking processing time when each of the plurality of articles is arranged at each of the plurality of arrangement positions;
acquire picking prediction information of the article;
evaluate a combination picking processing time corresponding to a plurality of arrangement position combinations based on the individual picking processing time and the picking prediction information; and
determine one arrangement position combination from among the plurality of arrangement position combinations based on the combination picking processing time.

2. The article management system according to claim 1,
wherein the one or more processors:
acquire picking history information in which a past picking processing time of the article for each of the arrangement positions is recorded; and
acquire the individual picking processing time based on the picking history information.

3. The article management system according to claim 2,
wherein the picking history information includes characteristic information of the arrangement position and characteristic information of the article, and
the one or more processors acquire combination determination target information including characteristic information of the arrangement position and characteristic information of the article of an arrangement position combination determination target, and acquire the individual picking processing time based on identity or similarity of the characteristic information of the arrangement position and identity or similarity of the characteristic information of the article in comparison between the picking history information and the combination determination target information.

4. The article management system according to claim 3,
wherein the characteristic information of the arrangement position includes information related to a size or a shape of the arrangement position, and
the characteristic information of the article includes information related to a type, a size, or a weight of the article.

5. The article management system according to claim 1,
wherein the one or more processors:
obtain an objective function including an evaluation term of the combination picking processing time; and
determine the arrangement position combination in which the objective function is minimized.

6. The article management system according to claim 5,
wherein the evaluation term of the combination picking processing time includes an evaluation term of a work time required for a picking work of the article at the arrangement position and an evaluation term of a transport time required to transport the article from the arrangement position to a predetermined shipping location.

7. The article management system according to claim 5,
wherein the objective function includes an evaluation term of a cost of changing an arrangement position of the article.

8. The article management system according to claim 5,
wherein the objective function includes an evaluation term of a constraint condition related to an arrangement position of the article.

9. The article management system according to claim 8,
wherein the evaluation term of the constraint condition is a function that increases the objective function when the same article is arranged at two or more arrangement positions.

10. An article management method of determining an arrangement position combination of a plurality of articles arranged at a plurality of arrangement positions,
wherein one or more processors execute:
acquiring an individual picking processing time when each of the plurality of articles is arranged at each of the plurality of arrangement positions;
acquiring picking prediction information of the article;
evaluating a combination picking processing time corresponding to a plurality of arrangement position combinations based on the individual picking processing time and the picking prediction information; and
determining one arrangement position combination from among the plurality of arrangement position combinations based on the combination picking processing time.

11. A non-transitory computer-readable recording medium having recorded thereon an article management program that determines an arrangement position combination of a plurality of articles arranged at a plurality of arrangement positions, the article management program causing one or more processors to execute:
acquiring an individual picking processing time when each of the plurality of articles is arranged at each of the plurality of arrangement positions;
acquiring picking prediction information of the article;
evaluating a combination picking processing time corresponding to a plurality of arrangement position combinations based on the individual picking processing time and the picking prediction information; and
determining one arrangement position combination from among the plurality of arrangement position combinations based on the combination picking processing time.
